(19) United States
(12) Patent Application Publication
(10) Pub. No.: US 2018/0262404 A1
(43) Pub. Date: Sep. 13, 2018

(54) HYPERMEDIA-DRIVEN RECORD AND PLAYBACK TEST FRAMEWORK

(71) Applicant: Microsoft Technology Licensing, LLC, Redmond, WA (US)

(72) Inventors: Zhao S. Su, Kirkland, WA (US); Prashanth Venkataraman, Bellevue, WA (US); Ganesh Sridharan, Redmond, WA (US); Huiwen Ru, Sammamish, WA (US); Alex D. Edelsburg, Seattle, WA (US); Stephane Taine, Issaquah, WA (US)

(73) Assignee: Microsoft Technology Licensing, LLC, Redmond, WA (US)

(21) Appl. No.: 15/457,177

(22) Filed: Mar. 13, 2017

(51) Int. Cl. H04L 12/24; H04L 12/927; H04L 29/08

(52) U.S. Cl. CPC H04L 41/509; H04L 67/02; H04L 47/801; H04L 41/5051

(57) ABSTRACT

The present disclosure is directed to systems, methods and devices for converting REST service events for playback. A plurality of web service resource requests comprising at least one operational event and at least one resource event may be received. At least one resource associated with the plurality of web service resource requests may be retrieved. Each operational event resource may be tagged. A correlation ID may be associated with each tagged operational event resource. A plurality of dynamic elements associated with the plurality of web service resource requests may be normalized. One or more event recording timelines for the plurality of web service resource requests may be identified, and the one or more event recording timelines may be evaluated during playback.

### BACKGROUND

For typical representational state transfer (REST) services, resources are represented as course grained entities with properties and links. Such resources can be manipulated and acted on by a user or application via CRUD (create, read, update, delete) operations on a corresponding uniform resource identifier (URI). Testing REST services for various web service applications typically requires tightly coupled interfaces to a specific web service application being tested in order to communicate with the REST service. The cost of developing and implementing these traditional tests is high and requires expensive maintenance in the event that the service being tested is modified. Additional challenges involved with developing a testing framework for these applications include the dynamic nature of resource links and the difficulty of determining user intent as it relates to REST service interactions.

Additionally, although relatively specific problems are discussed, it should be understood that the aspects should not be limited to solving only the specific problems identified in the background.

### SUMMARY

This summary is provided to introduce a selection of concepts in a simplified form that are further described below in the Detailed Description section. This summary is not intended to identify key features or essential feature of the claimed subject matter, nor is it intended to be used as an aid in determining the scope of the claimed subject matter.

Non-limiting examples of the present disclosure describe systems, methods and devices for providing REST service test frameworks. According to examples, one or more interactions with a web service may be tracked and each resource, event, and action associated with each web service interaction may be analyzed. One or more key frame events from each web service interaction may be identified and tagged for recording. A correlation ID may be assigned to each key frame event. The correlation IDs may provide generic mechanisms for identifying resources that may be interacted with by more than one actor during a web service interaction. Dynamic elements associated with each event, resource, and action may be normalized. That is, non-static elements associated with events, resources, and actions, such as URIs, may be removed or replaced with generic placeholders. Sequential identifiers may be assigned to each recorded resource, event, and action, and a recording timeline may be generated from those identifiers. The tagged key frame events, resources, and actions may be stored along with their corresponding metadata for playback testing.

In playback testing a sequence for executing each test event and resource is identified. As each test event and resource is loaded for execution, a determination is made as to whether satisfaction criteria is matched for those test elements. For example, a correlation identifier, a resource instance identifier, and a resource state may be matched to a corresponding recorded resource or event. If satisfaction criteria for a test element is matched, that test element is executed and a subsequent test element is loaded for execution until each test element from the test sequence is successfully executed, a test element fails to execute due to a satisfaction criteria non-match, or execution of a test element times out.

### BRIEF DESCRIPTION OF THE DRAWINGS

FIG. 1 is an exemplary schematic diagram of an environment for converting REST service events for playback.

FIG. 2 is a diagram illustrating an exemplary recording interaction diagram for converting REST service events for playback.

FIG. 3 is a diagram illustrating an exemplary environment for playing back recorded REST service events.

FIG. 4 illustrates an exemplary method for converting REST service events for playback.

FIG. 5 illustrates an exemplary method for playing back recorded REST service events.

FIGS. 6 and 7 are simplified block diagrams of a mobile computing device with which aspects of the disclosure may be practiced.

FIG. 8 is a block diagram illustrating example physical components of a computing device with which aspects of the disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Generally, the present disclosure is directed to systems, methods and devices for converting recorded REST service events for playback into generic REST service development test frameworks. The test frameworks may be generated by recording real-time web service interactions, and processing certain information related to those interactions to create generic event timelines that may be utilized for performing playback operations that allow users to simulate interactions with the service, and view the resulting REST service output (i.e., coded responses corresponding to input test interactions) based on input test commands.

For typical REST services, web resources are represented as course grained entities with properties and links. As referenced herein, a “web resource” or “resource” may describe concrete examples of concepts, such as an image, an address, a contact, etc., as well as operational resources, such as the operation of starting a phone audio conversation (e.g., a link to a phone number for a contact, a link to start a messaging conversation with a contact, etc.). A resource may have information associated with it, such as information regarding its state in the form of a property bag, an array of web links to related resources, and embedded resources.

Resources can be manipulated and acted upon by a user or application via CRUD operations (GET/POST/PUT/DELETE) on a corresponding universal resource identifier (URI). The GET operation is used to read, or retrieve, resources. POST is typically utilized to create new resources. In particular, it is used to create subordinate resources to some other resource (e.g., a parent resource). For example, when creating a new resource, a POST operation to the parent may be input and the service may then associate the new resource with the parent (e.g., associating a new resource URI for the new resource with the parent). PUT is often utilized for “update” capabilities, PUT-ing to a known resource URI with the request body containing the newly-updated representation of the original resource. However, PUT can also be used to create a resource in the case where the resource ID is chosen by the client instead of by the server. In other words, if the PUT is to a URI that contains the value of a non-existent resource ID. DELETE is simply used to delete a resource identified by a URI. Interactions with web service resources using CRUD operations may be recorded, saved, and played back in a deterministic manner.

There are difficulties with accurately providing a test framework for REST services. Difficulties in testing a REST service may result from data logs that are recorded during real-time web service interactions (e.g., interactions with call, video, or messaging web services), because interactions with such services generally involve a dynamic linking of resources and events. Dynamic data generated from interactions with REST services relates to systems that employ hypermedia, which generally encompasses extensions of hypertext, and relates to a nonlinear medium of information which includes graphics, audio, video, plain text and hyperlinks that may change based on various dynamic factors.

The dynamic nature of REST services may relate to modifications of URIs that link to a particular resource that is being accessed due to: a service that is being utilized to access that resource, user credentials associated with a service that is being utilized to access a resource, the time that a resource is being accessed, the location from which a resource is being accessed, etc. According to a specific example, a dynamic link may provide capabilities that a user has at particular moment in time (e.g., when a meeting attendee is in the lobby, an admit capability may appear, and after the attendee is admitted to the meeting, the admit link may no longer appear).

According to examples described herein, real-time services comprise applications such as voice communication services, video communication services, chat application services, and other services that provide real-time or near real-time web service dialogs between users and other web services for which the return of resources and event communications are desirable or necessary. For real-time communication services, each event has an associated “type” parameter, where started, updated, ad completed are operation events, and added, updated, and deleted are resource events.

Testing frameworks for real-time communication services that operate by means of APIs that recognize operational events and resource events have typically required development of service-specific software that takes into account the resource and event types associated with a specific service being tested, as well as a mechanism to accurately record interactions with that specific service.

Interactions that take place with REST services may be recorded, saved and played back in a deterministic manner for web service application testing (e.g., to ensure that updates to web service applications work appropriately and will not result in unintended user experiences, to ensure that runtime errors are eliminated from rollouts of new web service applications and web service application versions, performing web monitoring for a web service, providing REST service application development experience tools, etc.). Automating such experiences potentially replaces traditional software test development mechanisms, where tightly coupled interfaces are required in order to communicate and test a service. In turn, the high costs associated with developing and testing new web service applications, and updates to web service applications, may be greatly reduced by implementing aspects of the systems, methods, and devices described herein through automation of recording and playback mechanisms that are efficient, and capable of verifying the workability of new features and functionality in target applications.

According to examples, a framework may be provided for recording web service events whereby a plurality of web service resource requests are received and one or more resource associated with those requests may be retrieved. The plurality of web service resource requests may comprise operational events and resource events. Operational events comprise events such as started, updated, and completed. Alternatively, resource events comprise events such as added, updated, and deleted.

According to some examples, during a recording phase, event type information (e.g., whether an event is an operational event or a resource event, the specific type of operational or resource event) may be associated, or tagged, with each event that occurs over the course of a web service interaction. Similarly, target link information (links to resources that an event is about), and information sender link information (links pointing to the resource that generated an event, such as the owner or controller of a target resource), may also be associated with each event that occurs over the course of a web service interaction.

An event may contain a link to a modified resource, or for some resources, a link may include the resource content directly in the event. Links and resources generally share a common format, making it possible to write a client in a generic way so that it uses the embedded resource content when it is available, or retrieves it from a corresponding URI if it is not.

According to examples, each event that is tagged as an “operational event” during the recording of a web service interaction in a REST service test framework may be labeled as a “key frame” event. Key frame events act as filters that prune events and resources that are generated during user interaction, but that are unnecessary for providing useful feedback in a test framework. That is, key frame events are significant events that happen during a web service interaction, and the tagging of those events provides a marker for interpreting user intent based on user interaction with a resource corresponding to the key frame event.

According to additional examples, the noise associated with an event recording timeline may be eliminated prior to playback. The term “noise” as used herein refers to any resource that is not interacted with by a user. For example, the presence information for a contact in a chat application may represent a retrieved resource (e.g., a user may receive an indication that a user they are interacting with through a web service application is available, not available, busy, etc.). Presence information is typically viewed but not interacted with from a user standpoint, and that information is typically not useful for testing of such a service. As such, presence information may be eliminated from the recording and playback mechanisms of an exemplary REST service testing framework as described herein.

As discussed above, real-time communication REST resources are dynamic in nature. As such, for recording and playback purposes, URIs cannot simply be captured during recording because they will no longer be the same during playback. Therefore, according to examples, resources interacted with over the course of a web service interaction may be normalized and only the resource identifiers may be recorded (e.g., kept as metadata). That is, dynamic elements such as unique user IDs for users or devices that interact with resources, resource IDs that may change based on a temporal basis or the user or device that they are being accessed by, etc., may be normalized through the removal or conversion of the dynamic elements to a static identifier prior to playback, such as during recording of a web service interaction. For example, if a user interacting with a web service has acted on a resource during the course of a web service interaction, the resource identifier for that resource may be captured along with the operation (link token or CRUD) being performed, but the unique ID for the user and the resource may be normalized by removing the unique ID for the user and the resource or converting the unique ID for the user and the resource to a static identifier.

Normalization of resources may lead to event recordings where resources of the same type that have been interacted with during a web service interaction are generically represented in a recording and they may not be subsequently differentiated from one another during playback. According to examples, this may be corrected in a test framework by tagging each resource that is interacted with, with a corresponding correlation ID. For example, if an instant messaging conversation amongst multiple users or bots is recorded, a correlation ID may be assigned to each resource interaction to generically denote which users or bots were involved in each resource interaction (e.g., if person A sent a chat invitation to person B, a first correlation ID: 123 may be assigned for person A for that resource interaction, and a second correlation ID: 456 may be assigned for person B for that resource interaction).

According to some exemplary test framework examples, a determination may be made as to which resource events associated with a plurality of web service resource requests made during a web service interaction have been interacted with. Upon determining that one or more of the resource events was not interacted with, those events may be filtered from the recording so that they are not provided during the playback process for that web service interaction. For example, if during a web service interaction that is being recorded, a user receives an incoming call, and that user subsequently “accepts” the call, a plurality of “noise” resources and events (i.e., resources and events that the user did not interact with) may be received by the recording framework. Thus, the noise resource and events received during the web service interaction may be filtered from the recording so that they are not provided during the playback process.

According to additional examples, one or more event recording timeline may be identified for a web service interaction. For example, when information related to a web service interaction is received (e.g., information related to resources, events, user activities) sequentially, a unique and sequential ID may be associated with each received piece of information. Alternatively, a unique and sequential ID may only be associated with each piece of information that relates to a resource that was interacted with during the web service interaction. As such, when recording of a web service interaction is completed, associated unique IDs may be sorted into one or more timelines for the web service interaction.

The one or more identified timelines from a recorded web service interaction may be evaluated for a similar test interaction during playback of the recording. Evaluation of the one or more event recording timelines may comprise: matching playback satisfaction criteria for each of a plurality of playback events to metadata associated with each corresponding event recorded in the one or more event recording timelines. As used herein, “satisfaction criteria” comprises: a correlation identifier, a resource instance identifier, and a resource state, for each event, each of which may be associated as metadata with a corresponding recorded event during a web service interaction.

Upon determining that the satisfaction criteria for an event is matched during a recorded web service interaction, that event may be played back and displayed. That is, a playback engine may inspect the satisfaction criteria for each playback event against the satisfaction criteria for each corresponding recorded event from a web service interaction, and, upon making a determination that the satisfaction criteria is matched, the matched event may be played back and a subsequent event corresponding to the recorded timeline may be loaded for playback. According to some examples, a temporal threshold for determining whether the satisfaction for an event is matched may be provided such that when that temporal threshold is met or exceeded, a timeout for playing back that event may occur, and that event may not be displayed during playback.

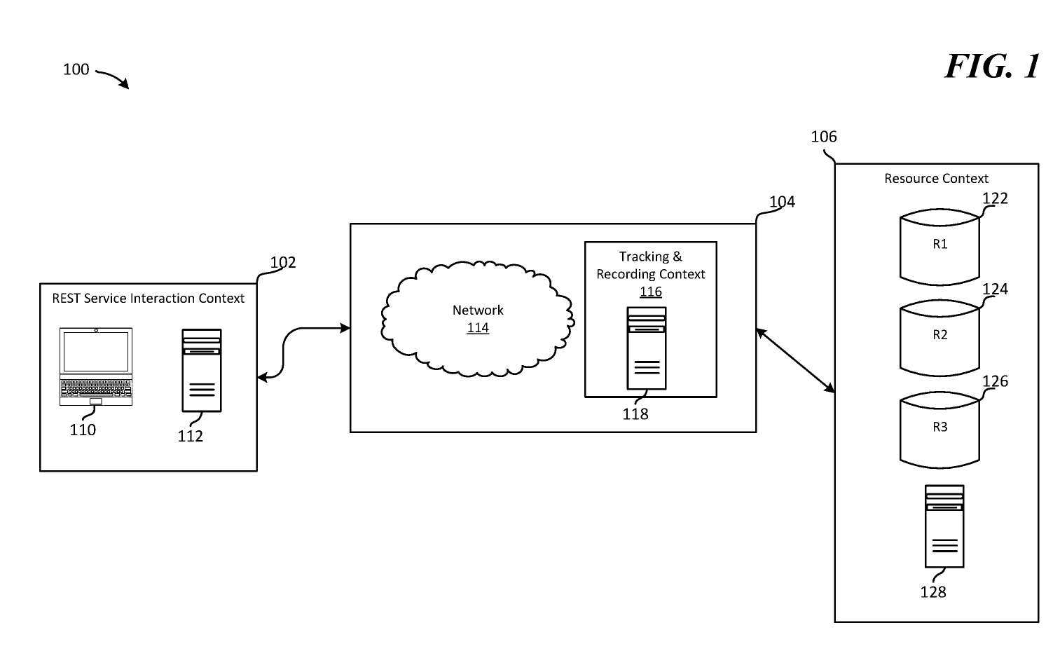

FIG. 1 is an exemplary schematic diagram of an environment 100 for converting REST service events for playback. Environment 100 includes REST service interaction context 102, REST service processing context 104, and resource context 106.

REST service interaction context includes one or more computing devices, including user computing device 110, and server computing device 112. A user may access user computing device 110 and interact with a REST web service, including real-time communication web services such as online meeting services, chat services, voice communication services, and video communication services. Interactions from user computing device 100 with a web service may be recorded and played back by one or more server computing devices, such as server computing device 112, in REST service interaction context 102, and server computing device 118 in tracking and recording context 116. The interactions between user computing device 100 and a REST web service, and devices associated with resource context 106, may be facilitated through network 114.

Resource context 106 includes one or more web service server computing devices, such as server computing device 128, as well as one or more resource databases, such as resource database 122, resource database 124, and resource database 126. Server computing device 128 may execute instructions for one or more web services, such as real-time REST communication web services as described herein. Each of resource databases 122, 124 and 126 may store resource information corresponding to one or more web services. Additionally, each of resource databases 122, 124 and 126 may receive resource requests from web services generated from user computing device 110, by way of network 114 and server computing device 128 and its corresponding web service applications that it executes instructions for. Information related to those requests may be sent back to user computing device 110 via network 114, and the events and resources associated with those interactions may be recorded via server computing device 112 and/or server computing device 118.

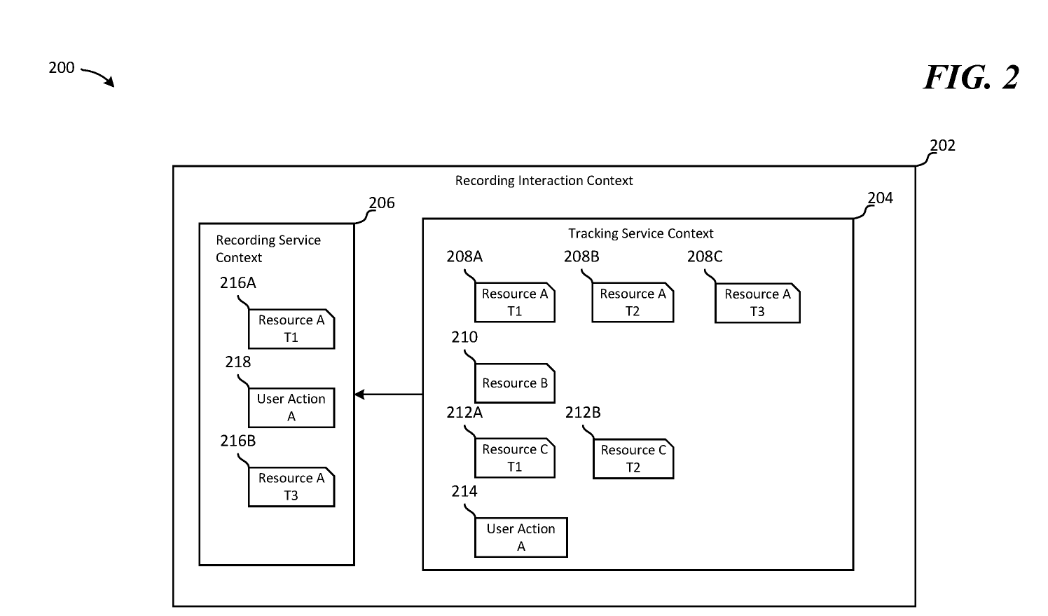

FIG. 2 is a diagram illustrating an exemplary recording interaction diagram 202 for converting REST service events for playback. Recording interaction context 202 includes tracking service context 204, and recording service context 206. According to examples, user interactions with a web service may be received and events and resources related to those interactions may be analyzed. For example, a user interacting with a REST web service may interact with a plurality of resources and passively cause a plurality of resource events to be sent or received based on the interaction. Each resource that is interacted with, each resource that is passively caused to be sent or received, and each event that occurs during the interaction, may be analyzed and tracked by one or more computing devices in tracking service context 204, and determinations may be made as to whether those resource and events, or information associated with those resources and events, should be recorded in recording service context 206.

In this example, tracking service context 204 has analyzed resource A, and a determination has been made, that resource A is part of a web service interaction. Resource A has been determined to have been interacted with or generated at resource A time one 208A, resource A time two 208B, and resource A time three time three 208C.

Tracking service context 204 has analyzed resource B, and a determination has been made, that resource B 210 is part of the same interaction as resource A.

Tracking service context 204 has analyzed resource C, and a determination has been made, that resource C is part of the same interaction as resources A and B. Resource C has been determined to have been interacted with or generated at resource C time one 212A, and resource C time two 212B.

Tracking service context 204 has analyzed user interaction 214, and a determination has been made, that user interaction associated with one of resources A-C has occurred.

One or more of the following operations may be performed by one or more computing devices associated with tracking service context 204:

1. Tracking all events and resources that occurred during recording;

2. Filtering noise events and resources and tagging the operation resources as key frame events;

3. Computing a correlation ID based on a conversation resource;

4. Capturing user action in relation to key frame events;

5. Computing a recording timeline based on the key frame events and user interaction (and inputs); and

6. Identifying relevant information for creating a web service testing framework from one or more of operations one through five above for recording in recording service context 206.

One or more computing devices in recording service context 206 may receive and record identified relevant information for creating a web service testing framework from one or more of operations one through five performed in tracking service 204. The identified relevant information in this example corresponds to resource A at time one 216A, user action A 218 and resource A at time three 216B. Thus, according to examples, resource A at time one 216A, and resource A at time three 216B, have been identified as a key frame event. That is, resource A at time one 216A, and resource A at time three 216B, have been identified as a significant operational events and they may be tagged with metadata designating those instances as key frame events for storage in recording service context 206.

Alternatively, resource A at time two 208B, and resource A at time three 208C may relate to resource events that were not interacted with (i.e., noise events), which have been filtered, and are therefore not recorded in recording service context 206. Resource B 210 may similarly relate to a resource event that was not interacted with, and therefore it has not been recorded in recording service context 206. Likewise, resource C at time one 212A, and resource C at time two 212B, may relate to resource events that were not interacted with, and therefore they have not been recorded in recording service context 206.

According to a specific example, resource A may correspond to a resource such as a joinOnlineMeeting resource. Specifically, resource A at time one 208A may correspond to a “started” event for that resource, resource A at time two 208B may correspond to an “updated” event associated with that resource, and resource A at time three 208C may correspond to a “completed” event associated with that resource. According to this specific example, user Action 214 may correspond to a user accepting a request to join the online meeting. This action constitutes an operation event and it may thus be tagged as a key frame event and stored in recording context 206. Similarly, because resource A at time one 216A was interacted with (i.e., the online meeting request was created by a user), and resource A at time three 216B was interacted with (i.e., a user closed the meeting and effectively “completed” the joinOnlineMeeting event) those resources are tagged as key frame events and stored in recording service context 206.

Alternatively, resource 210 B and resource C may correspond to updates regarding the status of one or more individuals that are party to the online meeting. Those resources were not interacted with and therefore they are not stored in recording service context 206.

An exemplary recording for a REST call service interaction is provided below. In this exemplary REST service interaction, a user has accepted an incoming audio call and subsequently transferred that call to another user.

```
Entries”: [
        {
          “EntryType”: “ResourceKeyframeEvent”,
          “KeyframeEvent”: {
            “ResourceName”: “audioVideoInvitation”,
            “Action”: “Started”,
            “CorrelationId”: “conversation0”,
            “ResourceInstanceId”: 0,
            “ConditionProperties”: {
              “direction”: “Incoming”
            },
            “ConditionLinks”: { }
          }
        },
        {
          “EntryType”: “ResourceUserActionEvent”,
          “UserAction”: {
            “CorrelationId”: “conversation0”,
            “ResourceInstanceId”: 0,
            “RequestingResourceName”: “audioVideoInvitation”,
            “ResourceName”: “acceptWithAnswer”,
            “ConditionProperties”: { },
            “ConditionLinks”: { },
            “RequestOperation”: “Post”,
            “UserInputs”: [
              {
                “Name”: “sessionContext”,
                “Value”: “abc”,
                “UseQueryParameter”: true
              }
            ],
            “RequestId”: 0,
            “RecordedResponseCode”: 204
          }
        },
        {
          “EntryType”: “ResourceKeyframeEvent”,
          “KeyframeEvent”: {
            “ResourceName”: “audioVideoInvitation”,
            “Action”: “Completed”,
            “CorrelationId”: “conversation0”,
            “ResourceInstanceId”: 0,
            “ConditionProperties”: {
              “direction”: “Incoming”
            },
            “ConditionLinks”: { }
      }
    },
    {
      “EntryType”: “ResourceUserActionEvent”,
      “UserAction”: {
        “CorrelationId”: “conversation0”,
        “ResourceInstanceId”: 0,
        “RequestingResourceName”: “audioVideo”,
        “ResourceName”: “transfer”,
        “ConditionProperties”: { },
        “ConditionLinks”: { },
        “RequestOperation”: “Post”,
        “UserInputs”: [
          {
            “Name”: “operationId”,
            “Value”: “123”,
            “UseQueryParameter”: false
          },
          {
            “Name”: “to”,
            “Value”: “sip:ucapuser15@ucaptenant.com”,
            “UseQueryParameter”: false
          }
          ],
          “RequestId”: 1,
        “RecordedResponseCode”: 201
      }
    },
    {
      “EntryType”: “ResourceKeyframeEvent”,
      “KeyframeEvent”: {
          “ResourceName”: “transfer”,
          “Action”: “Started”,
        “CorrelationId”: “conversation0”,
        “ResourceInstanceId”: 0,
        “ConditionProperties”: { },
          “ConditionLinks”: { }
      }
    },
    {
      “EntryType”: “ResourceKeyframeEvent”,
      “KeyframeEvent”: {
        “ResourceName”: “transfer”,
          “Action”: “Completed”,
          “Status”: “Success”,
        “CorrelationId”: “conversation0”,
    “ResourceInstanceId”: 0,
    “ConditionProperties”: { },
    “ConditionLinks”: { }
```

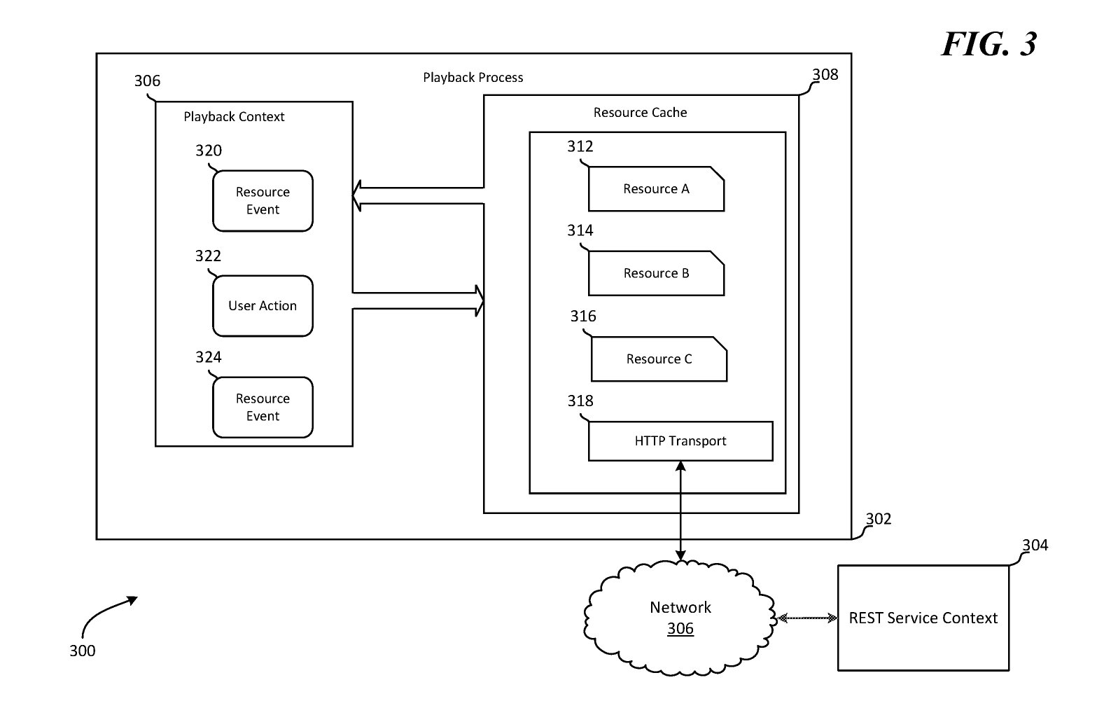

FIG. 3 is a diagram illustrating an exemplary environment 300 for playing back recorded REST service events. Exemplary environment 300 includes playback context 306 and resource cache 308, which relate to a REST service playback context in which operations may be performed by one or more computing devices in that context. Exemplary environment 300 also includes network 306 and REST service context 304.

REST service context 304 includes user interactions with a web service, tracking of the events and resources related to those interactions, and recording of identified relevant interactions for web service testing. The recorded events and resources may be transferred, by way of network 306 and HTTP transport 318, to resource cache 308 for surfacing during test playback.

One or more of the following operations may be performed by one or more computing devices associated with playback context 306:

1. Monitoring all events and resources during playback;

2. For invitation resources, as those resources and events get raised, computing a correlation ID for each resource where more than one actor (users interacting with resources in a web service interaction) is involved in the web service interaction;

3. Grouping and associating each resource to an existing correlation ID.

4. Determining whether each resource event satisfies a currently executing recording entry;

4(a). If all conditions match;

4(b) For user actions—executing the interaction with the captured user input;

4(c) For each executed interaction, removing the entry;

4(d) When an interaction is executed, loading the next entry and executing it until either the last entry for an event timeline has been executed or an interaction has failed to be executed.

According to the example shown in FIG. 3, one or more resource test events and test actions may be input into a REST service test framework in playback context 306. For example, resource event 320 may be a first test event, user action may be a first test action, and resource event 324 may be a second test event. As each test event and test action is received one or more corresponding resource, such as resource A 312, resource B 314, and resource C 316 in resource cache 308, recorded during a related web service interaction, may be identified and a corresponding resource event may be executed if the playback event matches playback satisfaction criteria with a corresponding recorded event. That is, for each event that is being tested in playback context 306, a correlation identifier, a resource instance identifier, and a resource state may be matched to a corresponding event in resource cache 308. Upon determining that a playback event matches playback satisfaction criteria with a corresponding recorded event, that event may be executed and a subsequent playback event may be loaded for execution until either each event from an event timeline has been executed or an event has timed out and failed.

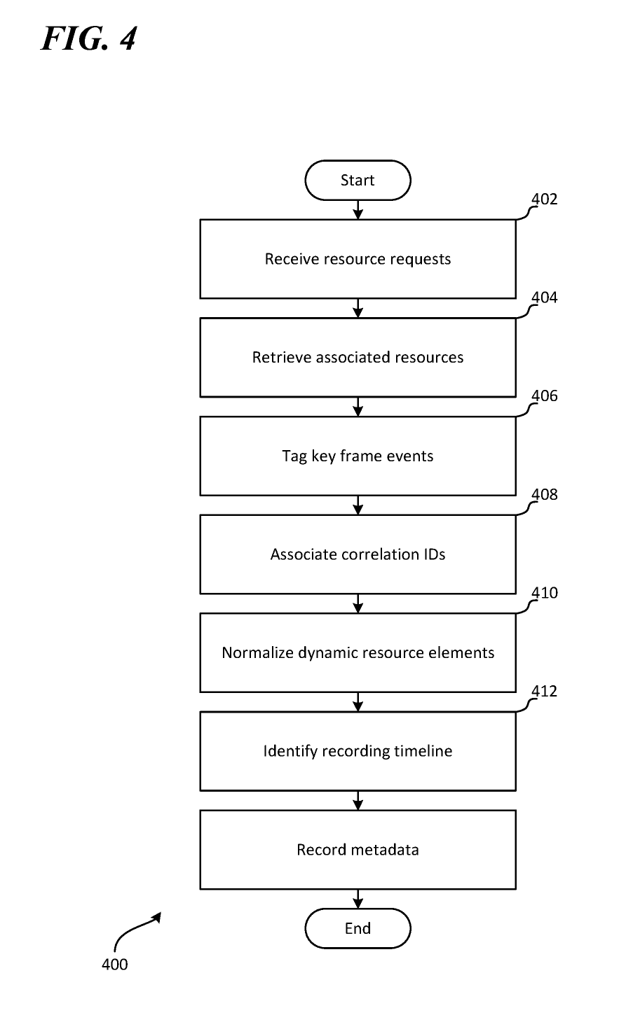

FIG. 4 illustrates an exemplary method 400 for converting REST service events for playback. The method 400 begins at a start operation and moves to operation 402 where one or more resource requests are received. The plurality of web service resource requests may comprise operational events, such as started, updated and completed; and resource events, such as added, updated, and deleted.

From operation 402, flow continues to operation 404, where one or more resources associated with the one or more requests may be retrieved from a corresponding web service or a resource repository that hosts resource data for a corresponding web service.

From operation 404, flow continues to operation 406, where one or more key frame events are tagged. Key frame events are operational events which act as filters. That is, key frame events prune events and resources that are generated during user interaction, but that are unnecessary for providing useful information in a test playback framework.

Moving from operation 406, flow continues to operation 408, where a correlation ID is associated with each tagged operational event resource. A correlation ID is simply a generic identification tag that may be associated with event resources that may be interacted with by more than one entity (e.g., a user, a bot, etc.) during the course of a web service interaction. For example, if an instant messaging conversation amongst multiple users or bots is recorded, a correlation ID may be assigned to each resource interaction to generically denote which users or bots were involved in each resource interaction.

From operation 408, flow continues to operation 410, where dynamic resource elements are normalized. That is, because real-time communication REST service resources are dynamic in nature, for recording and playback purposes, URIs cannot simply be captured during recording because they will no longer be the same during playback. Therefore, according to examples, resources interacted with over the course of a web service interaction may be normalized and only the resource identifiers may be recorded. Specifically, dynamic elements, such as unique user IDs for users or devices that interact with resources, resource IDs that may change based on a temporal basis or the user or device that they are being accessed by, etc., may be removed or converted to a generic identifier prior to playback, such as during recording of a web service interaction. For example, if a user interacting with a web service has acted on a resource during the course of a web service interaction, the resource identifier for that resource may be captured along with the operation (link token or CRUD) being performed, but the unique ID for the user and the resource may be removed or converted to a static generic identifier.

Continuing from operation 410, flow continues to operation 412, where one or more recording timeline for a web service interaction may be identified. For example, when information related to a web service interaction is received (e.g., information related to resources, events, user activities) sequentially, a unique and sequential ID may be associated with each received piece of information. Alternatively, a unique and sequential ID may only be associated with each piece of information that relates to a resource that was interacted with during the web service interaction. As such, when recording of a web service interaction is completed, associated unique IDs may be sorted into one or more timelines for the web service interaction.

Moving from operation 412, flow continues to operation 414, where metadata associated with a processed web service interaction is recorded. Recorded metadata may include event and resource types, whether an event has been tagged as key frame event, sequential identifiers corresponding to a recording timeline, correlation identifiers, resource instance identifiers, and resource states.

From operation 414, flow continues to an end operation and the method ends.

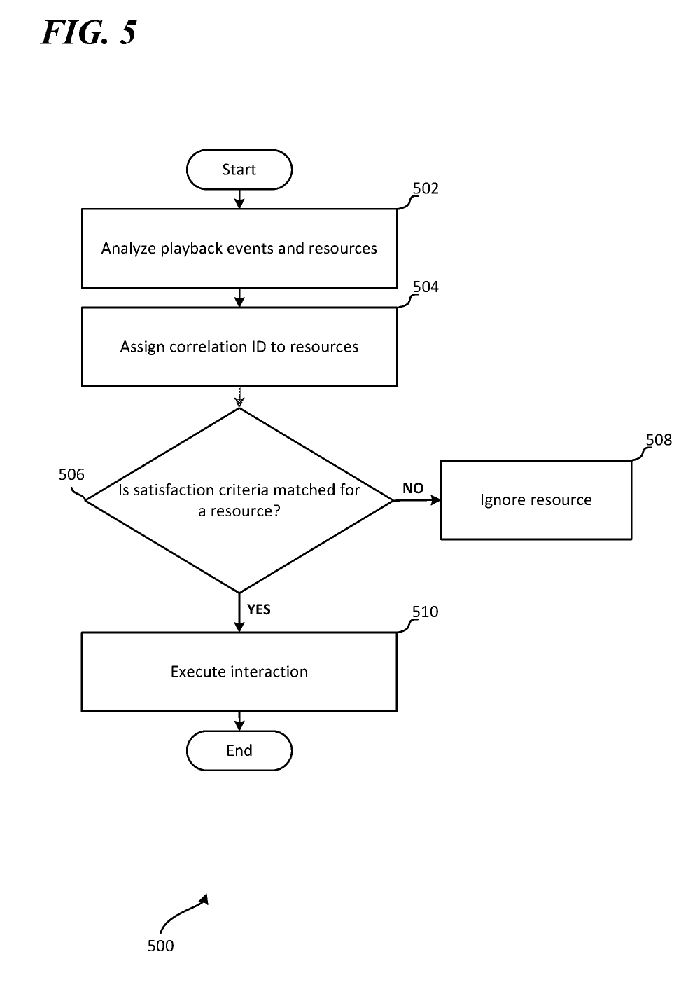

FIG. 5 illustrates an exemplary method 500 for playing back recorded REST service events. The method 500 begins at a start operation and continues to operation 502, where playback events and resources are analyzed. Analysis of playback events and resources may comprise identifying a sequence in which to play back one or more of the events and resources, inspecting metadata associated with each event and resource (e.g., event type and resource type metadata, key frame tagging metadata, sequential identifier metadata, resource instance identifiers, resource state identifiers, etc.).

Moving from operation 502, flow continues to operation 504, where a correlation ID is assigned to each resource being played back. That is, like in recording, a correlation ID may be associated with test event resources. The correlation ID is simply a generic identification tag that may be associated with test event resources that may be interacted with by more than one entity (e.g., a user, a bot, etc.) during the course of a test web service interaction.

From operation 504, flow continues to operation 506, where a determination is made as to whether satisfaction criteria is matched for a resource. As each test event and test action is received for execution, satisfaction criteria metadata for those events or actions may be compared with satisfaction criteria metadata for a corresponding recorded test event or test action. That is, for each test event or action that is being executed, a correlation identifier, a resource instance identifier, and a resource state may be matched to a corresponding recorded event or action.

If a determination is made at operation 506 that satisfaction criteria is matched for the resource, flow continues to operation 510 where a corresponding interaction may be executed, and a subsequent event may be loaded for playback. Alternatively, if a determination is not made within a threshold time that satisfaction criteria is matched for the resource at operation 506, a timeout message may be provided as feedback, and the method 500 may end. If a determination is made at operation 506 that satisfaction criteria is not matched for the resource, flow continues to operation 508 where the resource is ignored for playback purposes and a subsequent resource is loaded for execution.

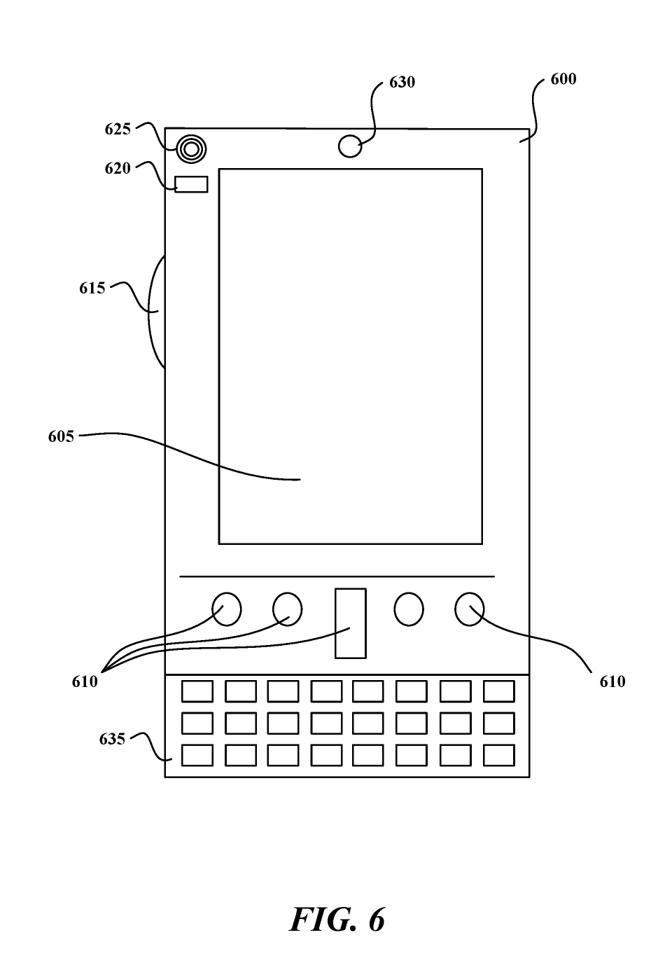

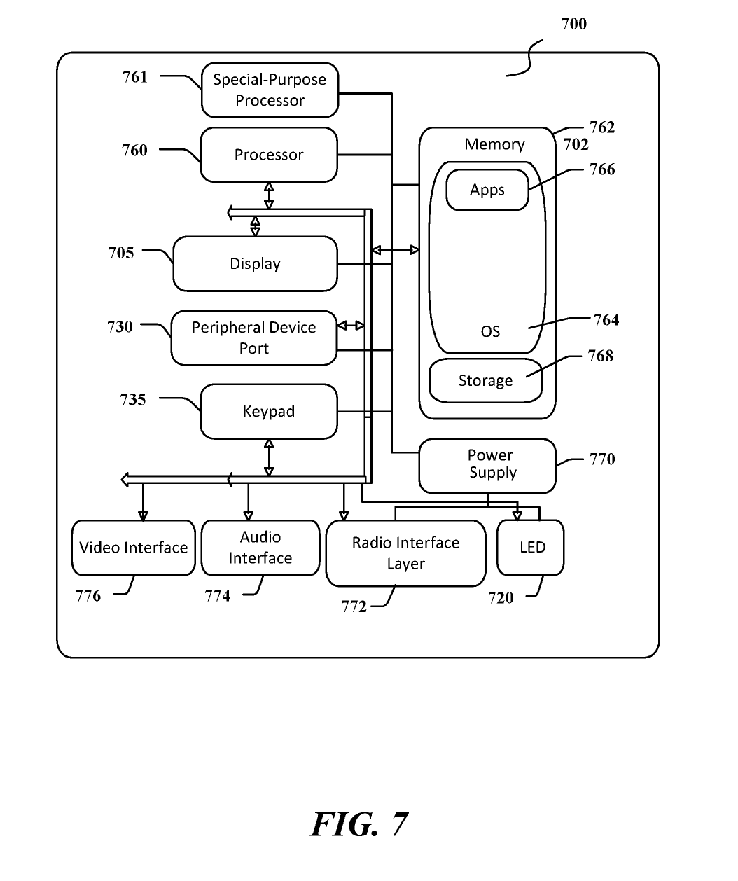

FIGS. 6 and 7 illustrate a mobile computing device 600, for example, a mobile telephone, a smart phone, wearable computer (such as a smart watch), a tablet computer, an e-reader, a laptop computer, and the like, with which embodiments of the disclosure may be practiced. In some aspects, the client may be a mobile computing device. With reference to FIG. 6, one aspect of a mobile computing device 600 for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display). If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some embodiments. In yet another alternative embodiment, the mobile computing device 600 is a portable phone system, such as a cellular phone. The mobile computing device 600 may also include an optional keypad 635. Optional keypad 635 may be a physical keypad or a “soft” keypad generated on the touch screen display. In various embodiments, the output elements include the display 605 for showing a graphical user interface (GUI), a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 7 is a block diagram illustrating the architecture of one aspect of a mobile computing device. That is, the mobile computing device 700 can incorporate a system (e.g., an architecture) 702 to implement some aspects. In one embodiment, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 864. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions for providing and operating a rules platform.

The system 702 has a power supply 770, which may be implemented as one or more batteries. The power supply 770 might further include an external power source, such as an AC adapter or a powered docking cradle that supplements or recharges the batteries.

The system 702 may also include a radio interface layer 772 that performs the function of transmitting and receiving radio frequency communications. The radio interface layer 772 facilitates wireless connectivity between the system 702 and the “outside world,” via a communications carrier or service provider. Transmissions to and from the radio interface layer 772 are conducted under control of the operating system 764. In other words, communications received by the radio interface layer 772 may be disseminated to the application programs 766 via the operating system 764, and vice versa.

The visual indicator 620 may be used to provide visual notifications, and/or an audio interface 774 may be used for producing audible notifications via the audio transducer 625. In the illustrated embodiment, the visual indicator 620 is a light emitting diode (LED) and the audio transducer 625 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 625, the audio interface 774 may also be coupled to a microphone to receive audible input, such as to facilitate a telephone conversation. In accordance with embodiments of the present disclosure, the microphone may also serve as an audio sensor to facilitate control of notifications, as will be described below. The system 702 may further include a video interface 776 that enables an operation of an on-board camera 630 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7 by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio interface layer 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio interface layer 772 or via a distributed computing network. Similarly, such data/information may be readily transferred between computing devices for storage and use according to well-known data/information transfer and storage means, including electronic mail and collaborative data/information sharing systems.

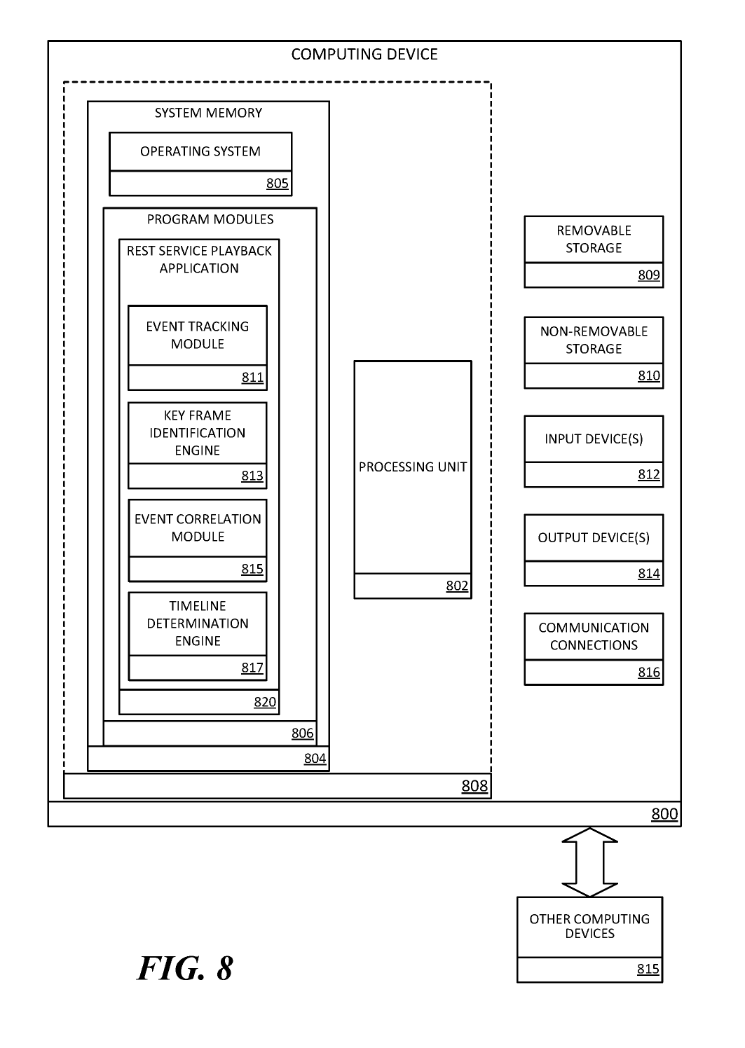

FIG. 8 is a block diagram illustrating physical components (e.g., hardware) of a computing device 800 with which aspects of the disclosure may be practiced. The computing device components described below may have computer executable instructions for converting REST service events for playback. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 suitable for running one or more REST service event playback conversion programs or one or more components in regards to FIG. 1. The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810.

As stated above, a number of program modules and data files may be stored in the system memory 804. While executing on the processing unit 802, the program modules 806 (e.g., static image conversion application 820) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 909, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

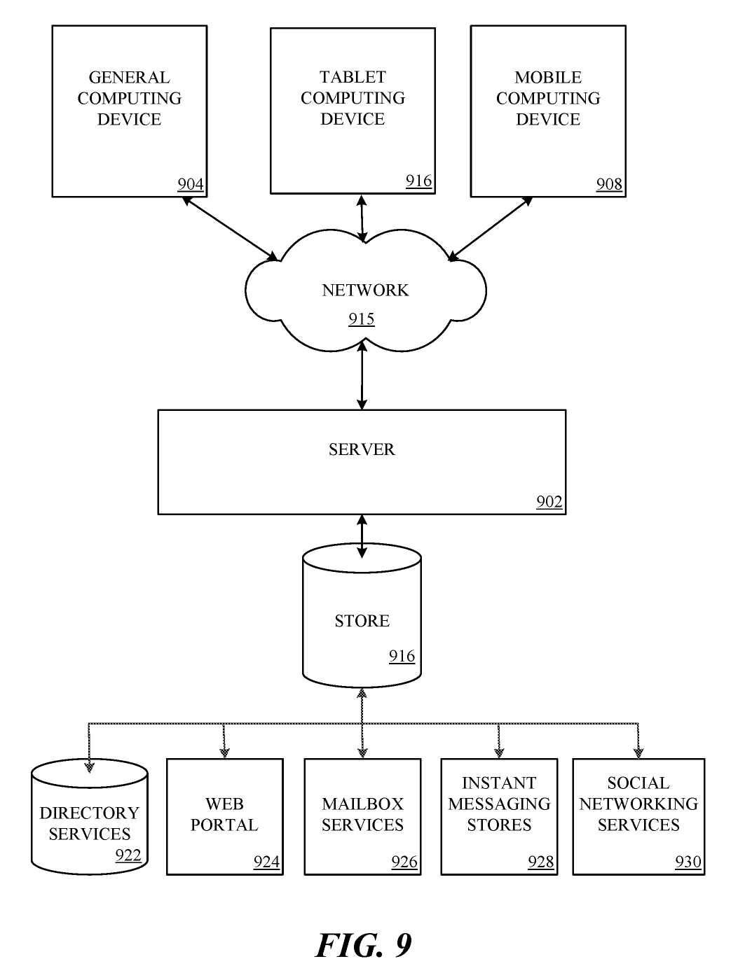

FIG. 9 illustrates one aspect of the architecture of a system for processing data received at a computing system from a remote source, such as a personal/general computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930. The program modules 806 may be employed by a client that communicates with server device 902, and/or the program modules 806 may be employed by server device 902. The server device 902 may provide data to and from a client computing device such as a personal/general computer 904, a tablet computing device 906 and/or a mobile computing device 908 (e.g., a smart phone) through a network 915. By way of example, the computer system described above with respect to FIGS. 6-10 may be embodied in a personal/general computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

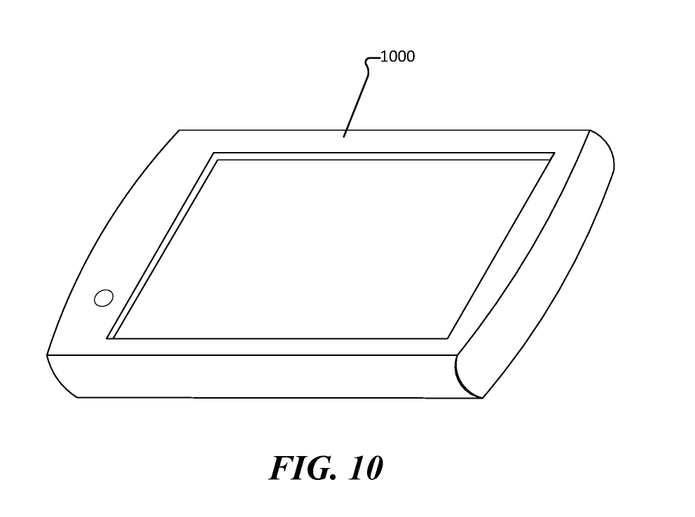

FIG. 10 illustrates an exemplary tablet computing device 1000 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

1. A method for converting REST service events for playback, comprising:
receiving a plurality of web service resource requests, the plurality of web service resource requests comprising at least one operational event and at least one resource event;
retrieving at least one resource associated with the plurality of web service resource requests;
tagging each operational event resource;
associating a correlation ID with each tagged operational event resource;
normalizing a plurality of dynamic elements associated with the plurality of web service resource requests;
identifying one or more event recording timelines for the plurality of web service resource requests; and
evaluating the one or more event recording timelines during playback.

2. The method of claim 1, wherein evaluating the one or more event recording timelines during playback further comprises:
matching playback satisfaction criteria for each of a plurality of playback events to metadata associated with each corresponding event recorded in the one or more event recording timelines, the satisfaction criteria comprising: a correlation identifier, a resource instance identifier, and a resource state for each event; and
executing each of the plurality of playback events for which the playback satisfaction criteria is matched.

3. The method of claim 2, further comprising timing out each playback event that fails to playback after a temporal threshold has expired.

4. The method of claim 1, further comprising:
determining which resource events associated with the plurality of web service resource requests have been interacted with; and
filtering each event that is determined not to have been interacted with.

5. The method of claim 1, wherein the operational event resources are selected from:
started, updated, and completed.

6. The method of claim 1, wherein the at least one resource associated with the plurality of web service resource requests are communications resources retrieved during real-time communications.

7. The method of claim 6, wherein a real-time communications API is used to retrieve the at least one resource.

8. The method of claim 1, wherein normalizing the plurality of dynamic elements associated with the plurality of web service resource requests comprises normalizing operational event resources.

9. The method of claim 1, wherein identifying the one or more event recording timelines for the plurality of web service resource requests comprises:
assigning a sequential identifier to each retrieved resource and each user event resource interaction; and
sorting each assigned sequential identifier by sequence number.

10. A computer-readable storage device comprising executable instructions, that when executed by a processor, assist with converting REST service events for playback, the computer-readable medium including instructions executable by the processor for:
receiving a plurality of web service resource requests, the plurality of web service resource requests comprising at least one operational event and at least one resource event;
retrieving at least one resource associated with the plurality of web service resource requests;
tagging each operational event resource;
associating a correlation ID with each tagged operational event resource;
normalizing a plurality of dynamic elements associated with the plurality of web service resource requests;
identifying one or more event recording timelines for the plurality of web service resource requests; and
evaluating the one or more event recording timelines during playback.

11. The computer-readable storage device of claim 10, wherein evaluating the one or more event recording timelines during playback further comprises:
matching playback satisfaction criteria for each of a plurality of playback events to metadata associated with each corresponding event recorded in the one or more event recording timelines, the satisfaction criteria comprising: a correlation identifier, a resource instance identifier, and a resource state for each event; and
executing each of the plurality of playback events for which the playback satisfaction criteria is matched.

12. The computer-readable storage device of claim 10, wherein the instructions are further executable by the processor for:
determining which resource events associated with the plurality of web service resource requests have been interacted with; and
filtering each event that is determined not to have been interacted with.

13. The computer-readable storage device of claim 10, wherein the operational resources are selected from: started, updated, and completed; and the resource events are selected from: added, updated, and deleted.

14. The computer-readable storage device of claim 10, wherein the at least one resource associated with the plurality of web service resource requests are communications resources retrieved during real-time communications.

15. The computer-readable storage device of claim 10, wherein normalizing the plurality of dynamic elements associated with the plurality of web service requests comprises normalizing operational event resources.

16. A system for assisting with converting REST service events for playback, comprising:
a memory for storing executable program code; and
a processor, functionally coupled to the memory, the processor being responsive to computer-executable instructions contained in the program code and operative to:
receive a plurality of web service resource requests, the plurality of web service resource requests comprising at least one operational event and at least one resource event;
retrieve at least one resource associated with the plurality of web service resource requests;
tag each operational event resource;
associate a correlation ID with each tagged operational event resource;
normalize a plurality of dynamic elements associated with the plurality of web service resource requests;
identify one or more event recording timelines for the plurality of web service resource requests; and
evaluate the one or more event recording timelines during playback.

17. The system of claim 16, wherein evaluating the one or more event recording timelines during playback further comprises:
matching playback satisfaction criteria for each of a plurality of playback events to metadata associated with each corresponding event recorded in the one or more event recording timelines, the satisfaction criteria comprising: a correlation identifier, a resource instance identifier, and a resource state for each event; and
executing each of the plurality of playback events for which the playback satisfaction criteria is matched.

18. The system of claim 17, further comprising:
determining which resource events associated with the plurality of web service resource requests have been interacted with; and
filtering each event that is determined not to have been interacted with.

19. The system of claim 17, wherein the at least one resource associated with the plurality of web service resource requests are communications resources retrieved during real-time communications.

20. The system of claim 17, wherein normalizing the plurality of dynamic elements associated with the plurality of web service requests comprises normalizing operational event resources.
